(19) United States
(12) Patent Application Publication
(10) Pub. No.: US 2025/0058524 A1
(43) Pub. Date: Feb. 20, 2025

(54) METHOD AND APPARATUS TO CLEAN ADDITIVELY MANUFACTURED COMPONENTS

(71) Applicant: A. RAYMOND ET CIE, Grenoble (FR)

(72) Inventors: Nicholas JACKSON, Davisburg, MI (US); Stefan SCHULZ, Lörrach (DE); Grégory ÉTIENNE, Mulhouse (FR)

(21) Appl. No.: 18/720,928

(22) PCT Filed: Dec. 23, 2022
(86) PCT No.: PCT/EP2022/087714

§ 371 Date: Jun. 17, 2024

Related U.S. Application Data
(60) Provisional application No. 63/294,149, filed on Dec. 28, 2021.

(51) Int. Cl. B29C 64/35; B08B 3/10; B33Y 40/20

(52) U.S. Cl. CPC B29C 64/35; B08B 3/102; B33Y 40/20

(57) ABSTRACT

The invention relates to a method to clean additively manufactured components, the method comprising the steps of: attaching at least one additively manufactured component to at least one holder, submerging the at least one additively manufactured component into a cleaning agent contained in a container, providing a gas to at least one bubble generator placed in the container below the at least one holder, inserting bubbles made of the gas from the at least one bubble generator into the cleaning agent, and removing spare material from the at least one additively manufactured component by the cleaning agent and the bubbles. Further, the invention relates to an apparatus for cleaning additively manufactured parts.

The present invention concerns a method and apparatus to clean additively manufactured components, especially resin-based additively manufactured components.

Additive manufacturing is used to build a component layer by layer. A very common additive manufacturing process is the resin-based manufacturing process, where resin is used as building material. Here liquid resin is filled into a pool and the bottom layer of the liquid resin is polymerized by light to form a first layer of the growing component. Afterwards the first layer is raised out of the pool, so that liquid resin flows below the first layer. Then, the second layer is polymerized by light. This process is repeated until the component is finished. Alternatively, the top layer of the liquid resin can be polymerized and then the top layer is immersed downwards into the resin pool. Subsequently, the resin can flow above the first layer and a second layer is polymerized by the light on top of the first layer.

Usually, when the additive manufacturing process is finished spare material remains on the surface of the additively manufactured components. In particular, liquid uncured resin can remain on the polymerized resin components. Since the additively manufactured components are usually cured after the manufacturing process, the spare material would also cure and would become part of the additively manufactured component. Thus, the additively manufactured component would exhibit an insufficient quality for example an insufficient production tolerance.

To prevent, that the spare material becomes part of the additively manufactured components, the components must be cleaned after the additive manufacturing process. To clean the additive manufacturing components, the additive manufacturing components are submerged into or are sprayed with a solvent. Nevertheless, the removal of spare material is difficult, especially since additive manufacturing components usually have a complex structure with cavities, interior spaces and so on. Thus, despite the cleaning spare material remains on the additively manufactured component.

From WO 2021/055743 A1 a cleaning method is known using vacuum cycling nucleation to remove the spare material. The method is expensive and a complex apparatus is needed to build up the vacuum, but still spare material remains on the sample.

Based on this state of the art the object of the present invention is to provide a method and an apparatus to clean additively manufactured components, especially resin-based additively manufactured components, with which the cleaning of additively manufactured components becomes less time-consuming, simpler, more efficient, and more cost-effective.

This object is solved by the method according to claim 1 and the apparatus according to claim15. Preferred embodiments are described in the subordinate claims and the description that follows here below.

This object is solved by a method to clean additively manufactured components, especially resin-based additively manufactured components, comprising the steps of:
Attaching at least one additively manufactured component to at least one holder,
submerging the at least one additively manufactured component into a cleaning agent contained in a container,
providing a gas to at least one bubble generator placed in the container below the at least one holder,
inserting bubbles made of the gas from the at least one bubble generator into the cleaning agent,
removing spare material, especially spare resin, from the at least one additively manufactured component by the cleaning agent and the bubbles.

By this method additively manufactured components are cleaned by the bubbles and the cleaning agent. The combination of a cleaning agent and bubbles leads to a more efficient cleaning, so that the cleaning is more time efficient. Further, the cleaning can be realised in a very simple way, while the method is cost-effective.

The at least one additively manufactured component is attached to at least one holder. A holder could be any device configured to keep the at least one additively manufactured component at a defined position or area inside the container. A holder can for example be clamping device, a basket, a hook, a screw connection and/or a counterpart to an attaching area of the at least one additively manufactured component.

The container is of any size capable to enclose the at least one holder and the at least one additively manufactured component. Further, the container is deep enough to submerge the at least one holder and the at least one additively manufactured component into the cleaning agent. In addition, the container is chemically stable to the cleaning agent. The container could be a drum, a vessel, a tub, etc.

Submerging means that the at least one additively manufactured component is at least parsurrounded by the cleaning agent. In this way, the at least one additively manufactured component can be cleaned. To submerge the at least one additively manufactured component a base can be connected to the at least one additively manufactured component. The base can be part of the at least one additively manufactured component and be attachable to the at least one holder. During cleaning the base of the at least one additively manufactured component can be partially submerged into the cleaning agent, so that the at least one holder is outside the cleaning agent. The base can be cut off from the at least one additively manufactured component after cleaning.

Alternatively, the at least one holder and the at least one additively manufactured component can be submerged into the cleaning agent during cleaning. In this way no additional base is necessary, so that structure of the at least one additively manufactured component can be simplified and the manufacturing process can be reduced.

The cleaning agent is a solution capable to remove the spare material of the at least one additively manufactured component. The cleaning agent could be water, isopropyl, Di(propylene glycol) methyl ether, RRC (RRC being a trade name of a solvent) or an alkaline detergent called PLM-450-SUB or a combination thereof. Di(propylene glycol) methyl ether can provide good cleaning results without influencing the material properties of the at least one additively manufactured component. In addition, alkaline detergents can be used as cleaning agent.

The gas provided to the bubble generator is of any type. The gas can be an unreactive gas or a reactive gas. An unreactive gas does not change the properties of the at least one additively manufactured component, while the reactive gas can be used for a more efficient cleaning and changing the surface properties of the at least one additively manufactured component. In particular, the gas can be an inert gas. An inert gas can positively influence the material properties. The gas can be air, nitrogen, oxygen, argon, carbon dioxide or a combination thereof.

The at least one bubble generator produces bubbles. In a very cost-effective embodiment, the at least one bubble generator can be a small tube with at least one hole inside. Furthermore, the at least one bubble generator for example can be using the Venturi principle, a swirling motion, a mixing principle, the principle of cavitation, the principle of pressure dissolution or any combination thereof.

The bubbles formed by the bubble generator from the provided gas reach the at least one additively manufactured component, where they collapse in the cleaning agent in contact with the at least one additively manufactured component. Thereby, the bubble wall velocities become supersonic because of the inertial forces in combination with the mass conservation. The energy released by the collapse of the bubble detaches the spare material from the at least one additively manufactured component. Due to the cleaning agent the resin's viscosity can be reduced, so that the energy released by the collapse of the bubble can be reduced. The spare material is then solved in the cleaning agent and in this way removed from the at least one additively manufactured component. Thus, the cleaning effect can be increased by the combination of bubbles and cleaning agent. Preferably, the size of the bubbles can be on a macro-scale to improve the cleaning effect.

The spare material to remove is any material attached to the at least one additively manufactured component, that is not part of the designed shape of the at least one additively manufactured component. Thus, the spare material must be removed to achieve the prescribed quality for example a sufficient production tolerance. In particular, the spare material can be spare resin.

In a first embodiment the method could further comprise the step:
Rotating the at least one holder inside the container around a first axes, especially around the vertical axis of the container, and
optionally spinning and/or tilting the at least one holder around a second and optionally around a third axes.

By doing so due to the additional rotation of the at least one additively manufactured component the cleaning can become more efficient in a simple manner. If the holder is rotated around the vertical axis of the container, the cleaning effect can become even better, since the bubbles can rise vertically along the at least one additively manufactured component, while the at least one additively manufactured component can be rotated horizontally through the cleaning agent. Each additional motion axis improves the cleaning effect further. The spinning around a second and optionally around a third axes can be realised by planetary spinning.

The rotation speed in rounds per minute for each axis can be from greater 0 min⁻¹ to 400 min⁻¹, preferably from greater 0 min⁻¹ to 300 min⁻¹ and particularly preferred from 100 min⁻¹ to 200 min⁻¹. Higher rotations speeds can increase the cleaning effect, while lower rotations speed can be used for fragile and/or filigree geometries, so the hydro dynamic forces do not unintentionally remove the parts from the holder.

In another embodiment the method could further comprise the steps:
Placing at least one spacer between at least two holders, and
submerging at least two holders in the container.

The at least one spacer can be any part that can keep the at least two holders at a given distance, so that the bubbles and the cleaning agent can reach every area of the at least one additively manufactured component. In doing so the cleaning method can become more cost-effective, since more additively manufactured components can be cleaned at the same time.

In another embodiment the method could further comprise the steps:
Filling fresh cleaning agent into the container and/or
removing used cleaning agent from the container.

The fresh cleaning agent can not be contaminated with spare material, while the used cleaning agent can be contaminated with spare material after the cleaning of the at least one additively manufactured component. The fresh cleaning agent can be filled into the container and the used cleaning agent can be removed from the container by an inlet and an outlet, respectively. Advantageously, it can be achieved that the at least one additively manufactured component can always be surrounded by fresh cleaning agent. Hence, the cleaning of the at least one additively manufactured component can be improved and the cleaning time is reduced.

In another embodiment the method could further comprise the step:
Purifying the cleaning agent.

The purifying can be achieved by separating the spare material from the cleaning agent, since the spare material can have a higher or lower density than the cleaning agent. Therefore, the spare material can gather at the top or bottom of the cleaning agent. Thus, the spare material can be removed from the cleaning agent by separating the top or bottom layer of the cleaning agent. The cleaning agent and the spare material can be separated inside the container or outside the container by a settling tank. Alternatively, the spare material and the cleaning agent can be separated by centrifugal forces.

By purifying the cleaning agent, the used cleaning agent can be recycled and used again. Thus, the method can become more efficient and more cost-effective.

In another embodiment the method could further comprise the step:
Heating or cooling the cleaning agent to facilitate the removal of spare material.

Heating the cleaning agent can be a very simple way to increase the cleaning-efficiency. Thereby, the cleaning time can be reduced. By cooling curing of the spare resin can be prevented, so that the removal of spare resin is simplified.

In another embodiment the method could further comprise the step:
Adjusting the bubble size, the number of bubbles and/or the distance between the at least one bubble generator and the at least one holder.

The bubble size can be the bubble diameter, which for example can be adjusted by the outlet diameter of the bubble generator. In particular, the diameter of the outlet of the bubble generator can be 1 mm to 2 mm, especially 1.5 mm. By adjusting the bubble size, the energy stored in each bubble can be adjusted, so that the cleaning power of the bubbles can be adapted to the material of the at least one additively manufactured component. Hence, the cleaning can become more efficient, so that the cleaning time can be reduced.

The number of bubbles for example can be adjusted by the gas pressure. On one hand, a large number of bubbles can fasten the cleaning, which can be useful, if a lot of spare material is left. On the other hand, using a smaller number of bubbles can lead to a more controlled cleaning, which can help to prevent any damage to the at least one additively manufactured component. Hence, by adjusting the number of bubbles the method becomes more efficient.

The distance between the at least one bubble generator and the at least one holder can be the vertical distance between the at least one bubble generator and the at least one holder. Thus, this distance determines the travel distance of the bubbles before they hit the at least one additively manufactured component. By adjusting the distance, the impact speed of the bubbles at the at least one additively manufactured component can be influenced. Thereby, the impact and thus the cleaning effect of the bubbles can be adjusted. This can lead to a more efficient cleaning.

The distance between the at least one bubble generator and the at least one holder can be adjusted by further submerging the at least one holder or by rising the at least one bubble generator.

Additionally, the cleaning time can be adjusted. In this way, a sufficient cleaning without damaging the at least one additively manufactured component can be guaranteed. Further, the amount of cleaning agent can be monitored for example by monitoring the cleaning agent level in the container.

In another embodiment the method could further comprise the step:
Moving the at least one bubble generator during the cleaning.

By moving the at least one bubble generator during the cleaning the position of the at least one bubble generator can be changed horizontally and vertically inside the container. In this way, the bubbles inserted by the at least one bubble generator can be focused on areas of the at least one additively manufactured component, which can exhibit excessive spare material. In addition, by moving the at least one bubble generator vertically, the cleaning effect of the bubbles can be adjusted. In this way the cleaning can be adapted to the spare material attached to the at least one additively manufactured component. Thus, the cleaning can become more effective in a simple manner leading to a reduced cleaning time.

In another embodiment the method could further comprise the steps:
Positively charging the at least one additively manufactured component, and/or
guiding the bubbles by a magnetic field and/or negative charge.

Since bubbles can usually exhibit a negatively charged surface, the bubbles can be attracted to a positive charge. The at least one additively manufactured component can be positively charged, for example through the holder, so that the bubbles can be attracted to the at least one additively manufactured component. In this way, the cleaning can become more effective and time efficient.

The bubbles can also be guided by a magnetic field and/or a negative charge. Since the bubbles are negatively charged, the bubbles can be guided by a magnetic field and/or by a negative charge through repulsion. Thus, the bubbles can be guided to the at least one additively manufactured component or certain areas of the at least one additively manufactured component. Thus, the cleaning can become more effective and time efficient.

In another embodiment the method could further comprise the step:
Identifying the at least one additively manufactured component and/or the at least one holder by an identification element, especially a bar code, a QR code and/or an NFC tag.

The identification element can be any readable mark, which can be used to identify the at least one additively manufactured component and/or the at least one holder. By identifying the at least one additively manufactured component and/or the at least one holder the cleaning parameters, for example the gas pressure, can be adapted to the at least one additively manufactured component. Thus, the cleaning can become more efficient in a simple manner.

If the at least one additively manufactured component and/or the at least one holder can be identified by a bar code, a QR code and/or an NFC tag, the bar code, QR code and/or the NFC tag can be read by a machine. This can further increase the efficiency and reduce the expenditure of time.

In another embodiment the method could further comprise the step:
Applying a sonication, especially an ultrasonic treatment, to support the removal of spare material.

A sonication, especially an ultrasonic treatment, can support the detachment of spare material, so that the cleaning can become faster.

In another embodiment the method could further comprise the step:
Monitoring the cleaning process by at least one accelerometer and/or at least one microphone.

By monitoring the cleaning process by at least one accelerometer the rotation speed of the holder can be checked to assure the correct cleaning parameters are applied. By monitoring the cleaning process by at least one microphone the cleaning by the bubbles can be checked. Each bubble can release a sound by collapsing. Hence, from the measured volume by the microphone the cleaning process can be monitored. In this way the method can become more reliable leading to more efficiency.

In another embodiment the method could further comprise the steps:
Dry spinning the at least one additively manufactured component before cleaning, and
optionally recovering the spare material.

Dry spinning can be a rotation of the at least one additively manufactured component at high speed to remove spare material. In this way, the amount of spare material before cleaning is reduced, so that the cleaning time and the cleaning costs can be reduced. If the spare material can be recovered, the costs are further reduced.

In another embodiment the method could further comprise the steps:
Manufacturing the at least one additively manufactured component by additive manufacturing, especially resin-based additive manufacturing, prior to the cleaning, and/or
curing the at least one additively manufactured component, especially by heating and/or microwave irradiating, after the cleaning.

By manufacturing the at least one additively manufactured component by additive manufacturing the at least one additively manufactured component can be simply produced and adapted for the cleaning process. For example, a mounting to attach the at least one additively manufactured component to the at least one holder can be included. Thus, the cleaning process is facilitated. In addition, a short time between the manufacturing and the cleaning of the at least one additively manufactured component can prevent, that the spare material can cure. Thus, the spare material can be easily removed.

By curing the at least one additively manufactured component the at least one additively manufactured component can be finished immediately after the cleaning. Thus, the at least one additively manufactured component can be finished fast and in a simple manner. Curing by heating and/or microwave irradiating can be very cost-effective.

This object is also solved by an apparatus for cleaning additively manufactured parts, especially resin-based additively manufactured parts, especially according to a method of any preceding claim,
with an container,
with at least one holder,
with an cleaning agent,
with a gas inlet,
with at least one bubble generator,
wherein the cleaning agent is inside the container,
wherein the at least one holder is submerged into the cleaning agent,
wherein the at least one holder is configured to hold at least one additively manufactured component,
wherein the gas inlet is connected to the bubble generator,
wherein the at least one bubble generator is placed below the at least one holder,
wherein the at least one bubble generator is configured to insert bubbles into the cleaning agent,
wherein the apparatus is configured to remove spare material, especially spare resin, of the at least one additively manufactured component by the cleaning agent and the bubbles.

With the apparatus the same advantages elucidated above for the method are achieved.

The exemplary configurations of the present invention that are described above in this description are also intended to be understood as disclosed in all combinations with one another. In particular, exemplary configurations are intended to be understood as disclosed in relation to the different aspects of the invention.

In particular, the description of method steps above or below in accordance with preferred embodiments of a method is also intended to disclose corresponding means for performing the method steps through preferred embodiments of an apparatus. Similarly, the disclosure of means of an apparatus for performing a method step is also intended to disclose the applicable method step.

Further advantageous exemplary configurations of the invention can be found in the detailed description below of some exemplary embodiments of the present invention, particularly in conjunction with the figures. However, the figures are intended to serve only the purpose of clarification, but not to determine the scope of protection of the invention. The figures are not to scale and are merely intended to reflect the general concept of the present invention by way of example. In particular, features that are contained in the figures are in no way intended to be regarded as a necessary part of the present invention.

### BRIEF DESCRIPTION OF THE FIGURES

In the figures:

FIG. 1 shows an exemplary embodiment of an apparatus used for a method according to the invention;

FIG. 2 shows another embodiment of an apparatus used for a method according to the invention;

FIG. 3 shows another embodiment of an apparatus used for a method according to the invention; and

FIG. 4 shows a flowchart for an embodiment of a method according to the invention.

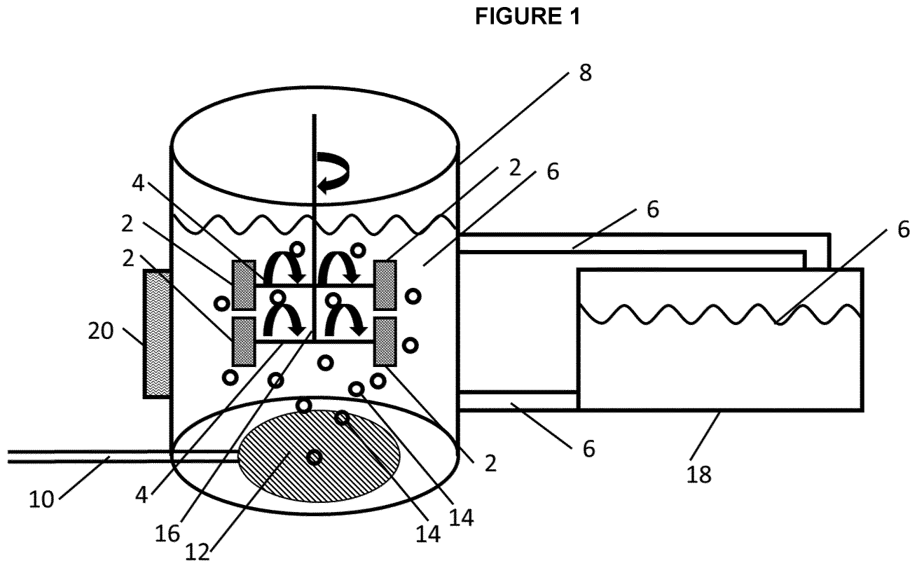

FIG. 1 shows an exemplary embodiment of an apparatus used for a method according to the invention.

The method to clean additively manufactured components 2, especially resin-based additively manufactured components 2 is described with reference to the apparatus shown in FIG. 1. Firstly, four additively manufactured components 2 are attached to four holders 4. Afterwards, the four additively manufactured components 2 are submerged into a cleaning agent 6 contained in the container 8. As shown in FIG. 1 the four holders 4 are also submerged into the cleaning agent 6. Alternatively, only the four additively manufactured components 2 can be submerged into the cleaning agent 6. A gas 10 is provided to a bubble generator 12 placed in the container 8 below the at least one holder 4. From the bubble generator 12 bubbles 14 made of the gas 10 are inserted into the cleaning agent 6. Spare material, especially spare resin, from the four additively manufactured components 2 is removed by the cleaning agent 6 and the bubbles 14.

As shown in FIG. 1 the four holders 4 are rotated inside the container 8 around a first axes, which is the vertical axis of the container. In addition, the four holders 4 are spinning around a second axes. To separate the four holders 4 a spacer 16 is placed in between the holders 4, before the holders 4 are submerged into the container 8.

Additionally, fresh cleaning agent 6 is filed into the container 8 at the bottom of the container 8, while used cleaning agent 6 is removed at the upper part of the container 8. Outside the container 8 the used cleaning agent 6 is purified by a settling tank 18. In the settling tank 18 the spare material separates from the cleaning agent and floats at the top of the settling tank 18. Thus, the fresh cleaning agent 6 is taken from the bottom of the settling tank 18.

Furthermore, the cleaning agent 6 is heated by a heater 20 to facilitate the removal of spare material. It is also possible to cool the cleaning agent 6. Before and during the cleaning the bubble 14 size, the number of bubbles 14 and/or the distance between the at least one bubble generator 12 and the at least one holder 4 can be adjusted. Additionally, the at least one bubble generator 12 can be moved during the cleaning.

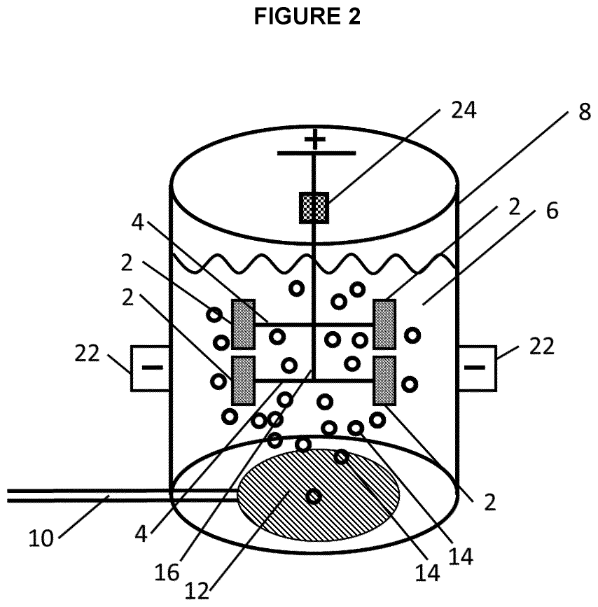

FIG. 2 shows another embodiment of an apparatus used for a method according to the invention. Since the embodiment shown in FIG. 2 is mostly the same as the ones shown in FIG. 1 only the differences to the embodiment of FIG. 1 are elucidated.

As shown in FIG. 2 the four additively manufactured components 2 are positively charged. In addition, the bubbles 14 are guided by a negative charge 22 applied at the sides of the container 8. Further, the four holders 4 can be identified by an identification element 24, which is a QR code 24.

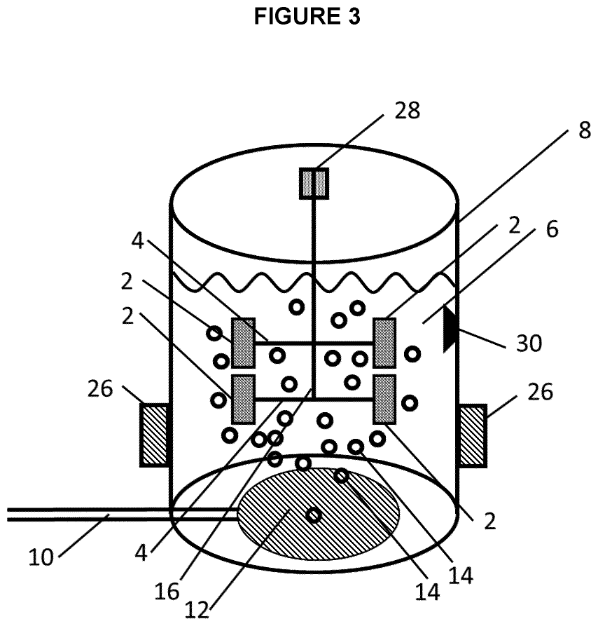

FIG. 3 shows another embodiment of an apparatus used for a method according to the invention. Since the embodiment shown in FIG. 3 is mostly the same as the ones shown in FIG. 1 and FIG. 2 only the differences to the embodiment of FIG. 1 are elucidated.

To support the removal of spare material a sonication 26, for example an ultrasonic treatment is applied. Moreover, the cleaning process is monitored by an accelerometer 28 and a microphone 30.

The four additively manufactured components 2 could be dry spined before the cleaning, whereby the spare material is recovered.

Further, the four additively manufactured components 2 are manufactured by additive manufacturing, especially resin-based additive manufacturing, prior to the cleaning. In addition, the four additively manufactured components 2 are cured by heating and/or microwave irradiating after the cleaning.

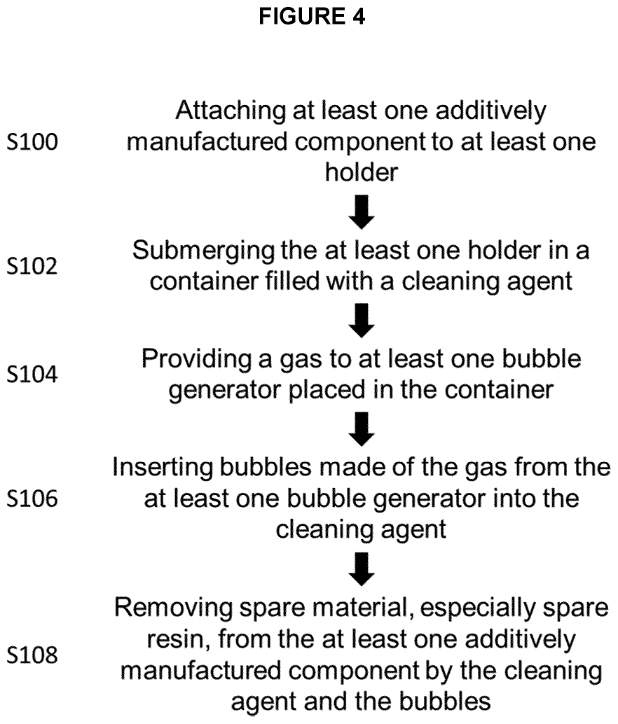

FIG. 4 shows a flowchart for an embodiment of a method according to the invention.

In step S100 the at least one additively manufactured component 2 is attached to at least one holder 4. Afterwards, in step S102 the at least one holder 4 is submerged into a cleaning agent 6 contained in the container 8 and then a gas 10 is provided to at least one bubble generator 12 placed in the container 8 in step S104. In step S106 bubbles 14 made of the gas 10 are inserted from the at least one bubble generator 12 into the cleaning agent 6. Finally, in step 108 spare material, especially spare resin, is removed from the at least one additively manufactured component by the cleaning agent and the bubbles.

1. A method to clean additively manufactured components, comprising the steps of:
attaching at least one additively manufactured component to at least one holder,
submerging the at least one additively manufactured component into a cleaning agent contained in a container,
providing a gas to at least one bubble generator placed in the container below the at least one holder,
inserting bubbles made of the gas from the at least one bubble generator-into the cleaning agent, and
removing spare material from the at least one additively manufactured component by the cleaning agent and the bubbles.

2. The method according to claim 1, further comprising the step:
rotating the at least one holder inside the container around a first axes, and
optionally spinning and/or tilting the at least one holder around a second and optionally a third axes.

3. The method according to claim 1, further comprising the steps:
placing at least one spacer between at least two holders, and
submerging at least two holders in the container.

4. The method according to claim 1, further comprising the steps:
filling fresh cleaning agent into the container, and/or
removing used cleaning agent from the container.

5. The method according to claim 1, further comprising the step:
purifying the cleaning agent.

6. The method according to claim 1, further comprising the step:
heating or cooling the cleaning agent to facilitate the removal of spare material.

7. The method according to claim 1, further comprising the step:
adjusting the bubble size, the number of bubbles and/or the distance between the at least one bubble generator and the at least one holder.

8. The method according to claim 1, further comprising the step:
moving the at least one bubble generator during the cleaning.

9. The method according to claim 1, further comprising the steps:
positively charging the at least one additively manufactured component, and/or
guiding the bubbles by a magnetic field and/or negative charge.

10. The method according to claim 1, further comprising the step:
identifying the at least one additively manufactured component and/or the at least one holder by an identification element.

11. The method according to claim 1, further comprising the step:
applying a sonication to support the removal of spare material.

12. The method according to claim 1, further comprising the step:
monitoring the cleaning process by at least one accelerometer and/or at least one microphone.

13. The method according to claim 1, further comprising the steps:
dry spinning the at least one additively manufactured component before cleaning, and
optionally recovering the spare material.

14. The method according to claim 1, further comprising the steps:
manufacturing the at least one additively manufactured component by additive manufacturing prior to the cleaning, and/or
curing the at least one additively manufactured component after the cleaning.

15. An apparatus for cleaning additively manufactured parts in accordance with the method of claim 1, the apparatus comprising:
at least one holder,
a cleaning agent,
a container,
a gas inlet,
at least one bubble generator,
wherein the cleaning agent is contained in the container,
wherein the at least one holder is submerged into the cleaning agent,
wherein the at least one holder is configured to attach to least one additively manufactured component,
wherein the gas inlet is connected to the bubble generator,
wherein the at least one bubble generator is placed below the at least one holder,
wherein the at least one bubble generator is configured to insert bubbles into the cleaning agent, and
wherein the apparatus is configured to remove spare material of the at least one additively manufactured component by the cleaning agent and the bubbles.
